(19) United States
(12) Patent Application Publication
(10) Pub. No.: US 2023/0049528 A1
(43) Pub. Date: Feb. 16, 2023

(54) CORNER BRAKE PRESSURE REDUCTION

(71) Applicant: GM Global Technology Operations LLC, Detroit, MI (US)

(72) Inventors: Christopher A. Henning, Royal Oak, MI (US); Bryan Larson, Fowlerville, MI (US); Patrick L. McInally, Farmington Hills, MI (US)

(21) Appl. No.: 17/401,658

(22) Filed: Aug. 13, 2021

(51) Int. Cl. B60T 8/24; B60T 8/171; B60T 8/32

(52) U.S. Cl. CPC B60T 8/246; B60T 8/171; B60T 8/321; B60T 2220/00; B60T 2250/04; B60T 2201/16

(57) ABSTRACT

A braking system for an automobile includes a controller adapted to independently control the brake pressure at each wheel of the automobile when an operator of the automobile applies the brakes, a first sensor adapted to measure an angular position of a steering wheel of the automobile and communicate the angular position of the steering wheel to the controller, and a second sensor adapted to measure a speed of the automobile and communicate the speed of the automobile to the controller, the controller further adapted to reduce the brake pressure at an inboard turning wheel when the speed of the vehicle is zero and the angular position of the steering wheel exceeds a pre-determined value.

### INTRODUCTION

The present disclosure relates to a braking system for an automobile and a method of controlling a braking system for an automobile that provides for reduction of the brake pressure at an inboard turning wheel to reduce the force necessary to turn the inboard turning wheel.

A multi-link suspension is desirable for vehicles as it improves ride characteristics when compared to a conventional suspension system. One significant drawback to using a multi-link suspension is higher static steering loads. Higher static steering loads result from migration of the king pin axis relative to the tire patch when the wheel is turned, causing the tire to be dragged, or scrubbed, across the surface of the road. This dragging or scrubbing increases the amount of force needed to turn the wheel, requiring a power steering module that is more powerful, and steering components and linkages that are more robust and able to handle the higher forces.

Thus, while current braking systems and method of controlling braking systems achieve their intended purpose, there is a need for an improved braking system and method of control that provides a reduction of the brake pressure at an inboard turning wheel, thus allowing the inboard turning wheel to freely rotate while being turned and reducing or eliminating dragging/scrubbing of the tire against the road surface and thereby reducing the force necessary to turn the inboard turning wheel.

### SUMMARY

According to several aspects of the present disclosure, a braking system for an automobile includes a controller adapted to independently control the brake pressure at each wheel of the automobile when an operator of the automobile applies the brakes, a first sensor adapted to measure an angular position of a steering wheel of the automobile and communicate the angular position of the steering wheel to the controller, and a second sensor adapted to measure a speed of the automobile and communicate the speed of the automobile to the controller, the controller further adapted to reduce the brake pressure at an inboard turning wheel when the speed of the vehicle is zero and the angular position of the steering wheel exceeds a pre-determined value.

According to another aspect, the braking system further includes a third sensor adapted to measure a force necessary to turn the inboard turning wheel of the automobile and communicate the force to the controller, wherein, the controller is adapted to reduce the brake pressure at the inboard turning wheel when the speed of the vehicle is zero and the force necessary to turn the inboard turning wheel of the automobile exceeds a pre-determined value.

According to another aspect, the controller is adapted to increase the brake pressure at each remaining wheel of the automobile when the brake pressure at the inboard turning wheel is reduced.

According to another aspect, the controller reduces the pressure of the inboard turning wheel, the controller is adapted to reduce the brake pressure at the inboard turning wheel to zero.

According to another aspect, when the controller reduces the pressure of the inboard turning wheel, the controller is adapted to gradually reduce the brake pressure at the inboard turning wheel from a normal braking pressure to zero.

According to another aspect, when the controller reduces the pressure of the inboard turning wheel, the controller is adapted to reduce the brake pressure at the inboard turning wheel from a normal braking pressure to zero as a step function.

According to another aspect, the controller is adapted to reduce the brake pressure at the inboard turning wheel when the speed of the vehicle is zero and the angular position of the steering wheel exceeds a pre-determined value and the force necessary to turn the inboard turning wheel of the automobile exceeds a pre-determined value.

According to several aspects of the present disclosure, a method of controlling a braking system for an automobile includes independently controlling, with a controller, the brake pressure at each wheel of the automobile when an operator of the automobile applies the brakes, detecting a speed of the automobile with a second sensor and communicating the speed of the automobile to the controller, detecting an angular position of a steering wheel within the automobile with a first sensor and communicating the angular position of the steering wheel to the controller, and reducing, with the controller, the brake pressure at an inboard turning wheel when the speed of the vehicle is zero and the angular position of the steering wheel exceeds a pre-determined value.

According to another aspect, the method further includes detecting a force necessary to turn the inboard turning wheel of the automobile with a third sensor and communicating the force to the controller, and reducing, with the controller, the brake pressure at the inboard turning wheel when the speed of the vehicle is zero and the force necessary to turn the inboard turning wheel of the automobile exceeds a pre-determined value.

According to another aspect, the method further includes increasing, with the controller, the brake pressure at each remaining wheel of the automobile whenever reducing, with the controller, the brake pressure at the inboard turning wheel of the automobile.

According to another aspect, the reducing, with the controller, the brake pressure at the inboard turning wheel when the speed of the vehicle is zero and the angular position of the steering wheel exceeds a pre-determined value and the reducing, with the controller, the brake pressure at the inboard turning wheel when the speed of the vehicle is zero and the force necessary to turn the inboard turning wheel of the automobile exceeds a pre-determined value further includes reducing, with the controller, the brake pressure at the inboard turning wheel to zero.

According to another aspect, the reducing, with the controller, the brake pressure at the inboard turning wheel when the speed of the vehicle is zero and the angular position of the steering wheel exceeds a pre-determined value and the reducing, with the controller, the brake pressure at the inboard turning wheel when the speed of the vehicle is zero and the force necessary to turn the inboard turning wheel of the automobile exceeds a pre-determined value further includes gradually reducing the brake pressure at the inboard turning wheel from a normal brake pressure to zero.

According to another aspect, the reducing, with the controller, the brake pressure at the inboard turning wheel when the speed of the vehicle is zero and the angular position of the steering wheel exceeds a pre-determined value and the reducing, with the controller, the brake pressure at the inboard turning wheel when the speed of the vehicle is zero and the force necessary to turn the inboard turning wheel of the automobile exceeds a pre-determined value further includes reducing the brake pressure at the inboard turning wheel from a normal brake pressure to zero as a step function.

According to another aspect, the method further includes reducing, with the controller, the brake pressure at the inboard turning wheel when the speed of the vehicle is zero and the angular position of the steering wheel exceeds a pre-determined value and the force necessary to turn the inboard turning wheel of the automobile exceeds a pre-determined value.

According to another aspect, the method further includes performing a verification check prior to reducing the brake pressure at the inboard turning wheel.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a braking system for an automobile according to an exemplary embodiment of the present disclosure, wherein the turning wheels of the automobile are straight;

FIG. 2 is a schematic view of a braking system for an automobile according to an exemplary embodiment of the present disclosure, wherein the turning wheels of the automobile are turned;

FIG. 3 is a perspective view of a steering wheel for an automobile with a braking system according to the present disclosure wherein the turning wheels of the automobile are straight;

FIG. 4 is a perspective view of a steering wheel for an automobile with a braking system according to the present disclosure wherein the turning wheels of the automobile are turned;

FIG. 5A is a graph of the braking pressure at an inboard turning wheel of an automobile vs. time, wherein the braking pressure at the inboard turning wheel is reduced to zero as a step function;

FIG. 5B is a graph of the braking pressure at an inboard turning wheel of an automobile vs. time, wherein the braking pressure at the inboard turning wheel is gradually reduced to zero;

FIG. 5C is a graph of the braking pressure at the remaining wheels of an automobile vs. time;

FIG. 6 is a graph of the force necessary to turn the inboard turning wheel vs. time, including a dashed plot wherein the pressure at the inboard turning wheel is not reduced, and a solid plot wherein the pressure at the inboard turning wheel is reduced; and

FIG. 7 is a flowchart illustrating a method of controlling a braking system in accordance with the present disclosure.

### DETAILED DESCRIPTION

The following description is merely exemplary in nature and is not intended to limit the present disclosure, application, or uses.

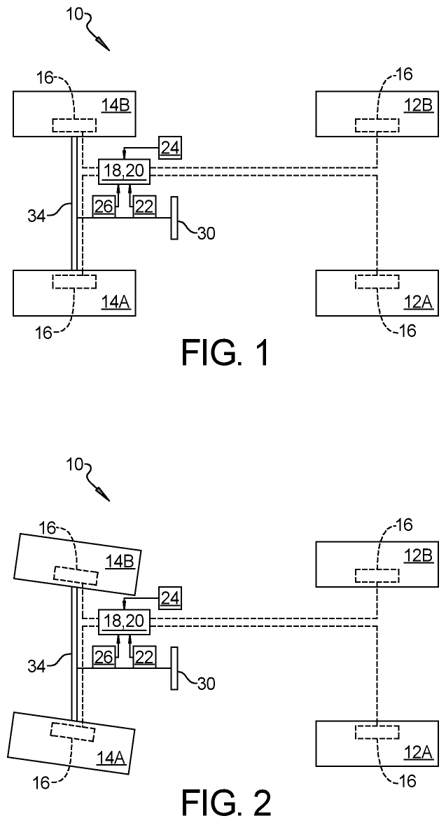

Referring to FIG. 1, a braking system for an automobile is shown generally at 10. As shown in FIG. 1, and for purposes of the description herein, the automobile is a typical four-wheel vehicle having two rear wheels 12A, 12B that are not steerable, and remain in a straight orientation at all times, and two front wheels 14A, 14B that articulate, allowing the automobile to be turned, as shown in FIG. 2. It should be understood that the novel concepts of the present disclosure are applicable to an automobile having more than four wheels and automobiles where either the front or rear or both the front and rear wheels articulate to allow the automobile to be turned.

Each of the wheels 12A, 12B, 14A, 14B includes a brake device 16 adapted to slow or stop rotation of the wheel 12A, 12B, 14A, 14B. The braking device 16 may be any suitable device such as, but not limited to, a shoe/caliper arrangement or shoe/drum arrangement. The braking system 10 includes a controller 18 that is adapted to independently control the brake pressure at each wheel 12A, 12B, 14A, 14B of the automobile when an operator of the automobile applies the brakes.

In an exemplary embodiment, the brake system 10 includes a master cylinder 20 that provides pressurized brake fluid to each of the brake devices 16. The controller 18 is associated with the master cylinder 20 and operates multiple valves located within the master cylinder 20 and at each brake device 16 to allow the controller 18 to control the pressure of the brake fluid provided to each brake device 16 independently, and independent of operator input.

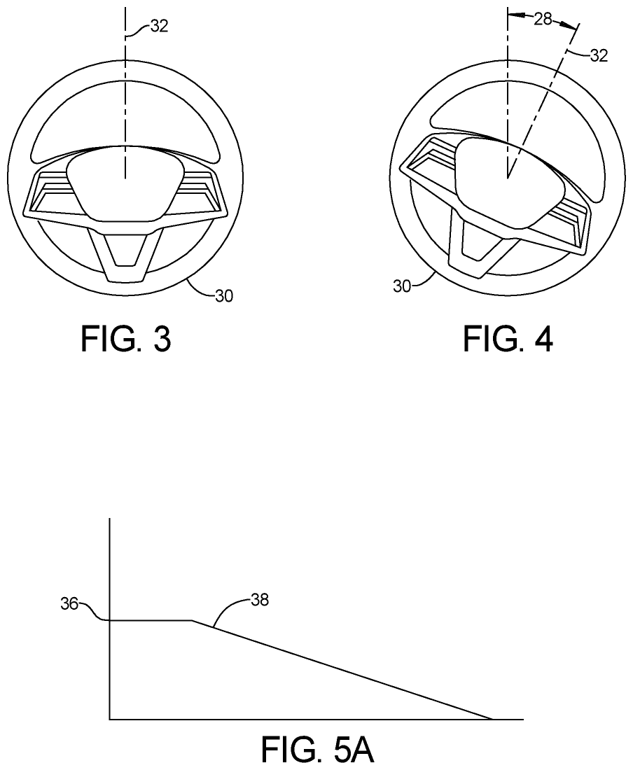

The brake system 10 includes sensors 22, 24, 26 that provide information to the controller 18. A first sensor 22 is adapted to measure an angular position 28 of a steering wheel 30 of the automobile and communicate the angular position 28 of the steering wheel 30 to the controller 18. Referring to FIG. 3, when the front wheels 14A, 14B of the automobile are straight, as shown in FIG. 1, the steering wheel is centered. A centerline 32 of the steering wheel 30 is parallel to the direction of travel. Referring to FIG. 4, when the front wheels 14A, 14B of the automobile are turned, as shown in FIG. 2, the centerline 32 of the steering wheel is rotated away from the centered position, shown in FIG. 3. The first sensor 22 measures the angular position 28 of the steering wheel 30 relative to the centered position.

A second sensor 24 is adapted to measure a speed of the automobile and communicate the speed of the automobile to the controller 18. A third sensor 26 is adapted to measure a force necessary to turn an inboard turning wheel 14B of the automobile and communicate the force to the controller 18. Referring to FIG. 2, when the front wheels 14A, 14B of the automobile are turned to the right, the front left wheel 14A is an outboard turning wheel 14A and the front right wheel 14B is an inboard turning wheel 14B. The third sensor 26 measures the force needed to actuate the steering linkage 34 of the automobile to articulate the front wheels 14A, 14B. The steering linkage 34 may be any suitable steering arrangement, such as, but not limited to a rack and pinion or other such linkage, which receives input from either the steering wheel 30 directly or through a power steering unit.

The controller 18 is adapted to reduce the brake fluid pressure, and therefore, the braking force at the braking device 16 of the inboard turning wheel 14B when certain conditions are present during turning of the automobile, thus allowing the inboard turning wheel 14B to freely rotate while being turned and reducing or eliminating dragging/scrubbing of the tire against the road surface and thereby reducing the force necessary to turn the inboard turning wheel 14B.

In one exemplary embodiment, the controller 18 is adapted to reduce the brake pressure at the inboard turning wheel 14B when the second sensor 24 indicates that the speed of the automobile is zero and the first sensor 22 indicates that the angular position 28 of the steering wheel 30 exceeds a pre-determined value. The pre-determined value of the angular position 28 of the steering wheel 30 is dependent upon aspects of the automobile and the suspension system of the automobile. For example, in one automobile, the pre-determined value of the angular position 28 of the steering wheel 30 may be 15 degrees, and in another application, for a different automobile with a different suspension system the pre-determined value of the angular position 28 of the steering wheel 30 may be 30 degrees. For any application, the pre-determined value of the angular position 28 of the steering wheel 30 is adapted to actuate pressure reduction of the brake fluid at the brake device 16 of the inboard turning wheel 14B when the forces necessary to turn the inboard turning wheel 14B begins to increase.

In another exemplary embodiment, the controller 18 is adapted to reduce the brake pressure at the inboard turning wheel 14B when the second sensor 24 indicates that the speed of the automobile is zero and the third sensor 26 indicates that the force necessary to turn the inboard turning wheel 14B exceeds a pre-determined value. The pre-determined value of the force necessary to turn the inboard turning wheel 14B is dependent upon aspects of the automobile and the suspension system of the automobile. Use of the braking system 10 and the method disclosed herein allows the suspension system of an automobile to be designed to withstand lower forces, thereby reducing costs and weight. For any application, the pre-determined value of the force necessary to turn the inboard turning wheel 14B is adapted to actuate pressure reduction of the brake fluid at the brake device 16 of the inboard turning wheel 14B when the forces necessary to turn the inboard turning wheel 14B begin to increase, and particularly to keep the forces within the limits of the suspension system.

In still another exemplary embodiment, the controller 18 is adapted to reduce the brake pressure at the inboard turning wheel 14B when the second sensor 24 indicates that the speed of the automobile is zero, the first sensor 22 indicates that the angular position 28 of the steering wheel 30 exceeds a pre-determined value and the third sensor 26 indicates that the force necessary to turn the inboard turning wheel 14B exceeds a pre-determined value.

When the controller 18 reduces the pressure of the inboard turning wheel 14B, the controller 18 is adapted to reduce the brake pressure at the braking device 16 of the inboard turning wheel 14B to zero. By effectively shutting the braking device 16 a the inboard turning wheel 14B off, the inboard turning wheel 14B is allowed to freely rotate while being turned, thus greatly reducing or eliminating any dragging or scrubbing of the tire against the road surface and thereby reducing the force necessary to turn the inboard turning wheel 14B.

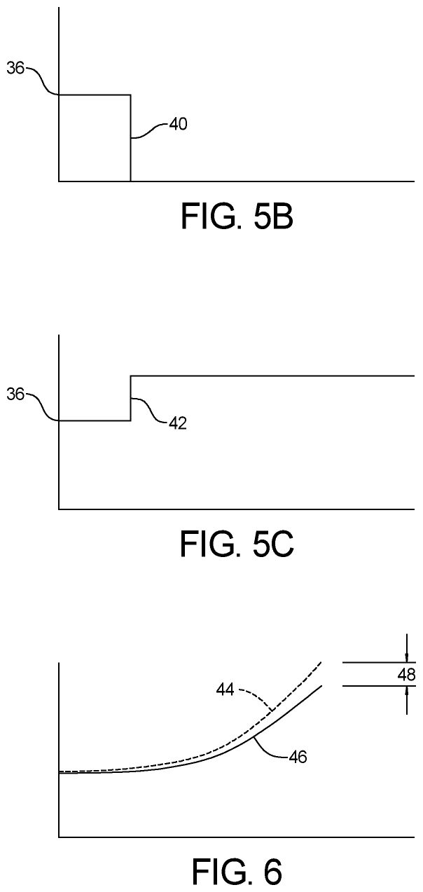

Referring to FIG. 5A, in one exemplary embodiment, when the controller 18 reduces the pressure of the braking fluid at the braking device 16 of the inboard turning wheel 14B, the controller 18 is adapted to gradually reduce the brake pressure at the inboard turning wheel 14B from a normal braking pressure 36 to zero. The plot 38 of the braking pressure vs. time illustrates the gradual falling off of the pressure.

Referring to FIG. 5B, in another exemplary embodiment, when the controller 18 reduces the pressure of the braking fluid at the braking device 16 of the inboard turning wheel 14B, the controller 18 is adapted to reduce the brake pressure at the inboard turning wheel 14B from the normal braking pressure 36 to zero as a step function. The plot 40 of the braking pressure vs. time illustrates the step, or nearly instant drop of the braking pressure from the normal braking pressure 40 to zero.

Referring to FIG. 5C, when the brake pressure at the inboard turning wheel 14B is reduced, the brake pressure at each of the remaining wheels 14A, 12A, 12B is increased. The increase in braking pressure at the brake devices 16 of the remaining wheels 14A, 12A, 12B provide for additional braking force to compensate for the reduced brake pressure at the inboard turning wheel 14B. The plot 42 of the brake pressure at each of the remaining wheels 14A, 12A, 12B vs time illustrates the increase in the braking pressure at each of the remaining wheels 14A, 12A, 12B simultaneously with reducing the braking pressure at the inboard turning wheel 14B.

Referring to FIG. 6, a plot of the force necessary to turn the inboard turning wheel 14B is shown, wherein the dashed line plot 44 illustrates the force vs. time as the inboard turning wheel 14B is turned without reducing the brake pressure at the inboard turning wheel 14B, and the solid line plot 46 illustrates the force vs. time as the inboard turning wheel 14B is turned with reduction of the brake pressure at the inboard turning wheel 14B. By allowing the inboard turning wheel 14B to freely rotate while being turned, the dragging or scrubbing of the tire against the road surface is reduced, thereby reducing the force necessary to turn the inboard turning wheel 14B, as shown at 46 in FIG. 6. It may be possible to reduce the force necessary to turn the inboard turning wheel 14B by as much as 10%, as shown at 48 in FIG. 6.

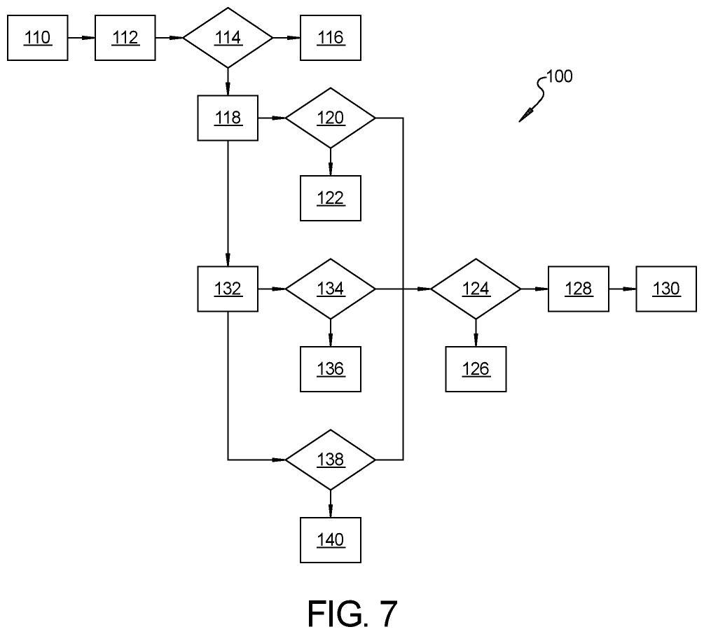

Referring to FIG. 7, a method 100 of controlling a braking system for an automobile is shown. Starting at block 110, the method includes independently controlling, with a controller 18, the brake pressure at each wheel 12A, 12B, 14A, 14B of the automobile when an operator of the automobile applies the brakes. Moving to block 112, the method includes detecting a speed of the automobile with a second sensor 24 and communicating the speed of the automobile to the controller 18. At block 114, the controller 18 determines if the speed of the automobile is zero. If the speed of the automobile is not zero, then, moving to block 116, the braking system 10 operates normally. If the speed of the automobile is zero, then, moving to block 118, the method includes detecting an angular position 28 of a steering wheel 30 within the automobile with a first sensor 22 and communicating the angular position 28 of the steering wheel 30 to the controller 18.

In one exemplary embodiment, moving to block 120, the controller 18 determines if the angular position 28 of the steering wheel 30 exceed a pre-determined value. If the angular position 28 of the steering wheel 30 does not exceed the pre-determined value, then, moving to block 122, the braking system 10 operates normally. If the angular position 28 of the steering wheel 30 exceeds the pre-determined value, then, moving to block 124, the method includes performing a verification check. If the verification check fails, then, moving to block 126, the braking system 10 defaults to operating normally. If the verification check passes, then, moving to block 128 the method includes reducing, with the controller 18, the brake pressure at an inboard turning wheel 14B, and simultaneously, moving to block 130, increasing, with the controller 18, the brake pressure at each remaining wheel 14A, 12A, 12B of the automobile.

In another exemplary embodiment, after detecting an angular position 28 of a steering wheel 30 within the automobile at block 118, moving to block 132, the method includes detecting a force necessary to turn the inboard turning wheel 14B of the automobile with a third sensor 26 and communicating the force to the controller 18. Moving to block 134, the controller 18 determines if the force necessary to turn the inboard turning wheel 14B of the automobile exceeds a pre-determined value. If the force necessary to turn the inboard turning wheel 14B of the automobile does not exceed the pre-determined value, then, moving to block 136, the braking system 10 operates normally. If the force necessary to turn the inboard turning wheel 14B of the automobile exceeds the pre-determined value, then, moving to block 124, the method includes performing a verification check. If the verification check fails, then, moving to block 126, the braking system 10 defaults to operating normally. If the verification check passes, then, moving to block 128 the method includes reducing, with the controller 18, the brake pressure at the inboard turning wheel 14B, and simultaneously, moving to block 130, increasing, with the controller 18, the brake pressure at each remaining wheel 14A, 12A, 12B of the automobile.

In still another exemplary embodiment, after detecting the angular position 28 of the steering wheel 30 within the automobile at block 118, and detecting a force necessary to turn the inboard turning wheel 14B of the automobile at block 132, moving to block 138, the controller 18 determines if the angular position 28 of the steering wheel 30 exceed the pre-determined value and determines if the force necessary to turn the inboard turning wheel 14B of the automobile exceeds the pre-determined value. If either the angular position 28 of the steering wheel 30 does not exceed the pre-determined value or the force necessary to turn the inboard turning wheel 14B of the automobile does not exceed the pre-determined value, then, moving to block 140, the braking system 10 operates normally. If both the angular position 28 of the steering wheel 30 exceeds the pre-determined value and the force necessary to turn the inboard turning wheel 14B of the automobile exceeds the pre-determined value, then, moving to block 124, the method includes performing a verification check. If the verification check fails, then, moving to block 126, the braking system 10 defaults to operating normally. If the verification check passes, then, moving to block 128 the method includes reducing, with the controller 18, the brake pressure at the inboard turning wheel 14B, and simultaneously, moving to block 130, increasing, with the controller 18, the brake pressure at each remaining wheel 14A, 12A, 12B of the automobile.

The verification check includes diagnostic evaluation of the data that is received from the first, second and third sensors 22, 24, 26 to verify that the sensors 22, 24, 26 are operating properly. If no data is being received from any one or more of the sensors 22, 24, 26, or if the data being received is not reliable, then the verification check is failed, and the brake system defaults to normal operation.

To ensure that the inboard turning wheel 14B is allowed to freely rotate while being turned, the reducing, with the controller 18, the brake pressure at the inboard turning wheel 14B when the speed of the automobile is zero and the angular position 28 of the steering wheel 30 exceeds a pre- determined value and the reducing, with the controller 18, the brake pressure at the inboard turning wheel 14B when the speed of the automobile is zero and the force necessary to turn the inboard turning wheel 14B of the automobile exceeds a pre-determined value further includes reducing, with the controller 18, the brake pressure at the inboard turning wheel 14B to zero. In one exemplary embodiment, the brake pressure at the inboard turning wheel 14B is gradually reduced from a normal brake pressure to zero. In another exemplary embodiment, the brake pressure at the inboard turning wheel 14B is reduced from a normal brake pressure to zero as a step function.

A braking system 10 and method 100 of the present disclosure offers the advantage of allowing the inboard turning wheel to freely rotate while being turned and reducing or eliminating dragging/scrubbing of the tire against the road surface and thereby reducing the force necessary to turn the inboard turning wheel.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A braking system for an automobile, comprising:
a controller adapted to independently control the brake pressure at each wheel of the automobile when an operator of the automobile applies the brakes;
a first sensor adapted to measure an angular position of a steering wheel of the automobile and communicate the angular position of the steering wheel to the controller; and
a second sensor adapted to measure a speed of the automobile and communicate the speed of the automobile to the controller;
the controller further adapted to reduce the brake pressure at an inboard turning wheel when the speed of the vehicle is zero and the angular position of the steering wheel exceeds a pre-determined value.

2. The braking system of claim 1, further including a third sensor adapted to measure a force necessary to turn the inboard turning wheel of the automobile and communicate the force to the controller, wherein, the controller is adapted to reduce the brake pressure at the inboard turning wheel when the speed of the vehicle is zero and the force necessary to turn the inboard turning wheel of the automobile exceeds a pre-determined value.

3. The braking system of claim 2, wherein the controller is adapted to increase the brake pressure at each remaining wheel of the automobile when the brake pressure at the inboard turning wheel is reduced.

4. The braking system of claim 3, wherein, when the controller reduces the pressure of the inboard turning wheel, the controller is adapted to reduce the brake pressure at the inboard turning wheel to zero.

5. The braking system of claim 4, wherein, when the controller reduces the pressure of the inboard turning wheel, the controller is adapted to gradually reduce the brake pressure at the inboard turning wheel from a normal braking pressure to zero.

6. The braking system of claim 4, wherein, when the controller reduces the pressure of the inboard turning wheel, the controller is adapted to reduce the brake pressure at the inboard turning wheel from a normal braking pressure to zero as a step function.

7. The braking system of claim 6, wherein the controller is adapted to reduce the brake pressure at the inboard turning wheel when the speed of the vehicle is zero and the angular position of the steering wheel exceeds a pre-determined value and the force necessary to turn the inboard turning wheel of the automobile exceeds a pre-determined value.

8. A method of controlling a braking system for an automobile, comprising:
independently controlling, with a controller, the brake pressure at each wheel of the automobile when an operator of the automobile applies the brakes;
detecting a speed of the automobile with a second sensor and communicating the speed of the automobile to the controller;
detecting an angular position of a steering wheel within the automobile with a first sensor and communicating the angular position of the steering wheel to the controller; and
reducing, with the controller, the brake pressure at an inboard turning wheel when the speed of the vehicle is zero and the angular position of the steering wheel exceeds a pre-determined value.

9. The method of claim 8, further including detecting a force necessary to turn the inboard turning wheel of the automobile with a third sensor and communicating the force to the controller, and
reducing, with the controller, the brake pressure at the inboard turning wheel when the speed of the vehicle is zero and the force necessary to turn the inboard turning wheel of the automobile exceeds a pre-determined value.

10. The method of claim 9, further including, increasing, with the controller, the brake pressure at each remaining wheel of the automobile whenever reducing, with the controller, the brake pressure at the inboard turning wheel of the automobile.

11. The method of claim 10, wherein, the reducing, with the controller, the brake pressure at the inboard turning wheel when the speed of the vehicle is zero and the angular position of the steering wheel exceeds a pre-determined value and the reducing, with the controller, the brake pressure at the inboard turning wheel when the speed of the vehicle is zero and the force necessary to turn the inboard turning wheel of the automobile exceeds a pre-determined value further includes reducing, with the controller, the brake pressure at the inboard turning wheel to zero.

12. The method of claim 11, wherein, the reducing, with the controller, the brake pressure at the inboard turning wheel when the speed of the vehicle is zero and the angular position of the steering wheel exceeds a pre-determined value and the reducing, with the controller, the brake pressure at the inboard turning wheel when the speed of the vehicle is zero and the force necessary to turn the inboard turning wheel of the automobile exceeds a pre-determined value further includes gradually reducing the brake pressure at the inboard turning wheel from a normal brake pressure to zero.

13. The method of claim 11, wherein, the reducing, with the controller, the brake pressure at the inboard turning wheel when the speed of the vehicle is zero and the angular position of the steering wheel exceeds a pre-determined value and the reducing, with the controller, the brake pressure at the inboard turning wheel when the speed of the vehicle is zero and the force necessary to turn the inboard turning wheel of the automobile exceeds a pre-determined value further includes reducing the brake pressure at the inboard turning wheel from a normal brake pressure to zero as a step function.

14. The method of claim 13, further including reducing, with the controller, the brake pressure at the inboard turning wheel when the speed of the vehicle is zero and the angular position of the steering wheel exceeds a pre-determined value and the force necessary to turn the inboard turning wheel of the automobile exceeds a pre-determined value.

15. The method of claim 14, further including performing a verification check prior to reducing the brake pressure at the inboard turning wheel.

16. A braking system for an automobile, comprising:
a controller adapted to independently control the brake pressure at each wheel of the automobile when an operator of the automobile applies the brakes;
a first sensor adapted to measure an angular position of a steering wheel of the automobile and communicate the angular position of the steering wheel to the controller;
a second sensor adapted to measure a speed of the automobile and communicate the speed of the automobile to the controller;
a third sensor adapted to measure a force necessary to turn an inboard turning wheel of the automobile and communicate the force to the controller;
the controller further adapted to reduce the brake pressure at the inboard turning wheel when one of:
the speed of the vehicle is zero and the angular position of the steering wheel exceeds a pre-determined value;
the speed of the vehicle is zero and the force necessary to turn the inboard turning wheel of the automobile exceeds a pre-determined value; and
the speed of the vehicle is zero and the angular position of the steering wheel exceeds a pre-determined value and the force necessary to turn the inboard turning wheel of the automobile exceeds a pre- determined value.

17. The braking system of claim 15, wherein the controller is adapted to increase the brake pressure at each remaining wheel of the automobile when the brake pressure at the inboard turning wheel is reduced.

18. The braking system of claim 17, wherein, when the controller reduces the pressure of the inboard turning wheel, the controller is adapted to reduce the brake pressure at the inboard turning wheel to zero.

19. The braking system of claim 18, wherein, when the controller reduces the pressure of the inboard turning wheel, the controller is adapted to gradually reduce the brake pressure at the inboard turning wheel from a normal brake pressure to zero.

20. The braking system of claim 18, wherein, when the controller reduces the pressure of the inboard turning wheel, the controller is adapted to reduce the brake pressure at the inboard turning wheel from a normal brake pressure to zero as a step function.
